(19) United States
(12) Patent Application Publication
(10) Pub. No.: US 2018/0291796 A1
(43) Pub. Date: Oct. 11, 2018

(54) COOLING FAN MODULE

(71) Applicant: Johnson Electric S.A., Murten (CH)

(72) Inventors: Ruifeng QIN, Hong Kong (CN); Xinhui GUAN, Shenzhen (CN); Jiyu LIANG, Shenzhen (CN)

(21) Appl. No.: 15/871,656

(22) Filed: Jan. 15, 2018

(30) Foreign Application Priority Data
Apr. 7, 2017 (CN) 2017 1022 5060.7

(51) Int. Cl. F01P 5/04; F01P 7/02; B60K 11/06; F04D 25/06; F04D 29/18

(52) U.S. Cl. CPC F01P 5/04; F01P 7/02; B60K 11/06; F01P 2005/046; F04D 25/064; F04D 29/181; F04D 25/0646

(57) ABSTRACT

A cooling fan module for heat dissipation of an automobile engine is provided. The cooling fan module includes a fan assembly and a brush motor for driving the fan assembly. The brush motor includes a stator having a housing and a plurality of permanent magnets fixed onto an inner wall of the housing, and a rotor including a shaft, a rotor core including a plurality of winding slots evenly distributed on a periphery of the rotor core, and a winding wound around the rotor core. The number of the permanent magnets is four, and the number of the winding slots is twenty-two, to make the brush motor have a small noise, and a long life.

### CROSS REFERENCE TO RELATED APPLICATIONS

This non-provisional patent application claims priority under 35 U. S. C. § 119(a) from Patent Application No. 201710225060.7 filed in The People's Republic of China on Apr. 7, 2017, the entire contents of which are hereby incorporated by reference.

### FIELD OF THE INVENTION

This present disclosure relates to a cooling fan module, particularly for cooling an automobile engine.

### BACKGROUND OF THE INVENTION

A cooling fan module includes a fan assembly, and a brush motor for driving the fan assembly. The brush motor includes a rotor with twenty slots and a stator with four poles. However, the cooling fan module has a large noise and vibration. In addition, the cooling fan module has a short life.

### SUMMARY

Thus, there a desire for a cooling fan module, which has a small noise, and a long life.

According to one aspect, a cooling fan module for heat dissipation of an automobile engine is provided, which includes a fan assembly and a brush motor for driving the fan assembly, The brush motor includes a stator including a housing and a plurality of permanent magnets fixed onto an inner wall of the housing, and a rotor including a shaft, a rotor core sleeved on the shaft, and a winding wound around the rotor core, the number of the permanent magnets is four, the rotor core comprises twenty-two winding slots evenly distributed on a periphery of the rotor core and twenty-two teeth, each tooth is formed between two adjacent winding slots, and the winding is wound around the teeth.

Preferably, the rotor core further comprises a plurality of laminations stacked along an axial direction of the brush motor, each lamination has twenty-two slots and twenty-two tooth portions, the slots are stacked to form the winding slots, and the tooth portions are stacked to form the teeth.

Preferably, each lamination is centrosymmetric.

Preferably, each winding slot is parallel to the axial direction of the brush motor.

Preferably, the winding slots are paralleled to each other, but inclined relative to the axial direction of the brush motor.

Preferably, an axial upper end of the winding slot is offset by an offset angle with respect to an axial lower end of the same winding slot, wherein the offset angle ranges from 7.98 degrees to 8.38 degrees.

Preferably, the offset angle is 8.18 degrees, the offset angle refers to an angle formed between a first dummy line and a second dummy line, the first dummy line refers to a projection of a line connecting the axial upper end and an axis of the brush motor, in an axial direction of the brush motor, the second dummy line refers to a projection of a line connecting the axial lower end and the axis, in the axial direction of the brush motor.

Preferably, the four permanent magnets are uniformly distributed on the inner wall of the housing in a circumferential direction of the brush motor, a radial inner surface of the permanent magnet has a central angle relative to an axis of the brush motor, and the central angle ranges from 79.8 degrees to 83.8 degrees, 71.6 degrees to 75.6 degrees, or 65.5 degrees or 73.6 degrees.

Preferably, a ratio of a diameter of the rotor core to a thickness of the rotor core is greater than 2.

Preferably, the stator further comprises a brush device mounted to one end of the housing, the rotor further comprises a commutator sleeved on the shaft, the commutator is connected to the winding and in contact with brushes of the brush device, the commutator comprises an insulating base sleeved on the shaft, twenty-two segments fixed to a radial outer periphery of the insulating base, and twenty-two insulating grooves, each insulating groove being formed between the two adjacent segments.

Preferably, a ratio of W1 to W2 ranges from 0.9 to 1.3, wherein W1 refers to a width of the brush, W2 refers to a sum of a width of the segment and a width of the insulating groove adjacent to the segment.

In the embodiments of the present disclosure, the brush motor is a 4-pole 22-slot motor, which has a small noise and a long lift.

### BRIEF DESCRIPTION OF THE DRAWINGS

A preferred embodiment of the invention will now be described, by way of example only, with reference to figures of the accompanying drawings. In the figures, identical structures, elements or parts that appear in more than one figure are generally labeled with a same reference numeral in all the figures in which they appear. Dimensions of components and features shown in the figures are generally chosen for convenience and clarity of presentation and are not necessarily shown to scale. The figures are listed below.

FIG. 1 is a schematic diagram of a cooling fan module according to a preferred exemplary embodiment of the present disclosure;

FIG. 2 is a schematic diagram of a motor of FIG. 1 according to a preferred exemplary embodiment of the present disclosure;

FIG. 3 is an exploded view of the motor of FIG. 2;

FIG. 4 is a schematic diagram of a stator pole of a stator of FIG. 3;

FIG. 5 is a schematic diagram of a brush device of FIG. 3;

FIG. 6 is a top view of a rotor core of FIG. 3;

FIG. 7 is a front view of the rotor core of FIG. 3;

FIG. 8 illustrates a comparison of a cogging torque of a 4-pole 20-slot motor according to the conventional technology and a cogging torque of a motor according to an implementation of the present disclosure;

FIG. 9 is a top view of an alternate rotor core according to some embodiments of the present disclosure;

FIG. 10 is a front view of the rotor core of FIG. 9;

FIG. 11 is a schematic diagram of a commutator of FIG. 3.

### DETAILED DESCRIPTION OF THE PREFERRED EMBODIMENTS

The subject matter will be described in conjunction with the accompanying drawings and the preferred embodiments. The described embodiments are only a few and not all of the embodiments of the present disclosure. All other embodiments obtained by those ordinarily skilled in the art based on the embodiments of the present disclosure without any creative efforts fall within the protection scope of the present disclosure. It is to be understood that, the drawings are provided for reference only and are not intended to be limiting of the invention. The dimensions shown in the drawings are only for convenience of illustration and are not intended to be limiting.

It should be noted that when a component is considered to be “connected” to another component, it can be directly connected to another component or may also have a centered component. Unless otherwise defined, all technical and scientific terms used herein have the same meaning as commonly understood by those ordinarily skilled in the art. The terminology used in the specification of the present disclosure is only for the purpose of describing particular embodiments and is not intended to limit the invention.

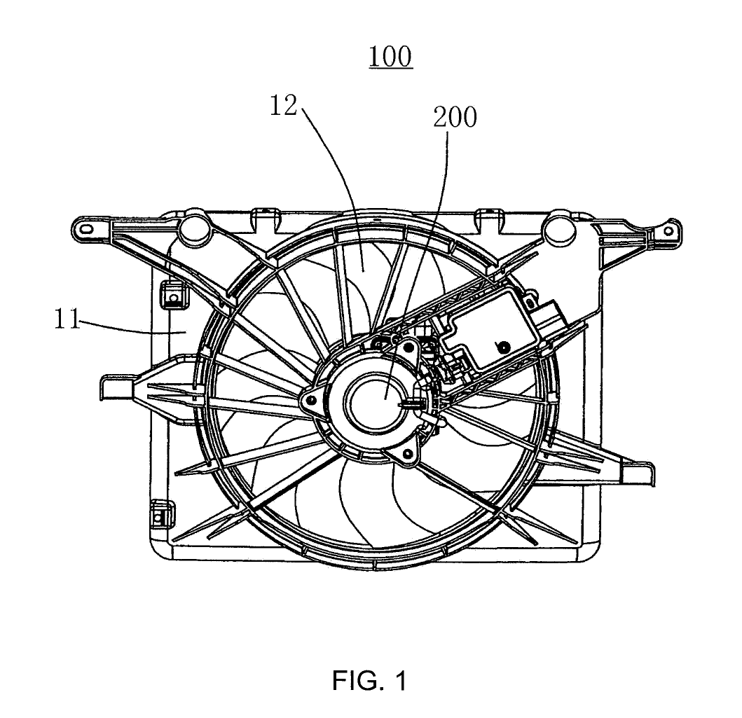

FIG. 1 schematically shows a cooling fan module 100, particularly for heat dissipation of an automobile engine. The cooling fan module 100 includes a fan assembly 12, and a motor 200 mounted on the fan assembly 12. The motor 200 is a brush motor, and configured for driving the fan assembly 12 to generate air.

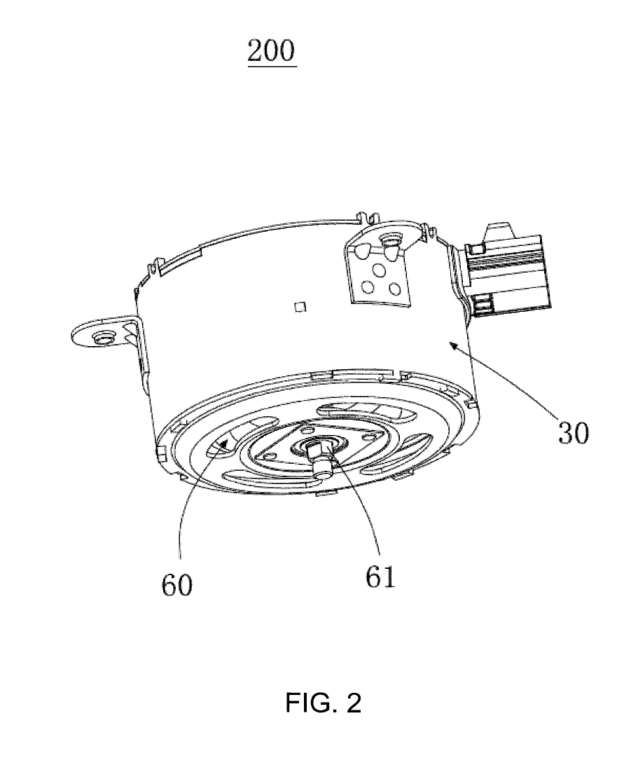

Referring to FIG. 2, in the embodiment, the motor is substantially a flat cylinder, with a shorter axial length and a longer diameter. The motor 200 includes a stator 30, and a rotor 60 rotatably disposed within the stator 30. The rotor 60 includes a shaft 61. One end of the shaft 61 protruding outside the stator 30 as an output shaft, to driving the fan assembly 12.

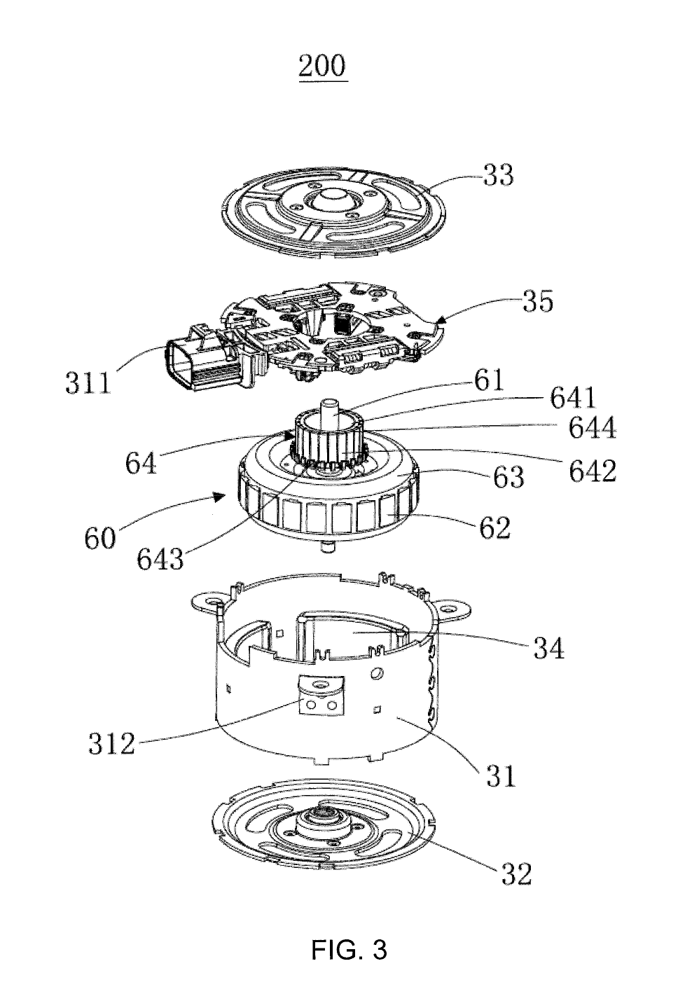

Referring to FIG. 3, the stator 30 includes an annular housing 31, four permanent magnets 34 fixed onto an inner wall of the housing 31, a brush device 35 mounted to one end of the housing 31, a first end cap 32 and a second end cap 33 respectively assembled on opposite ends of the housing 31. The housing 31 has a plurality of L-shaped mounting members 312 for fixing the stator 30 to the fan assembly 12. The permanent magnets 34 are uniformly distributed on the inner wall of the housing 31 in the circumferential direction of the motor 200. The four permanent magnets 34 form four stator poles, which including two North poles and two South Poles.

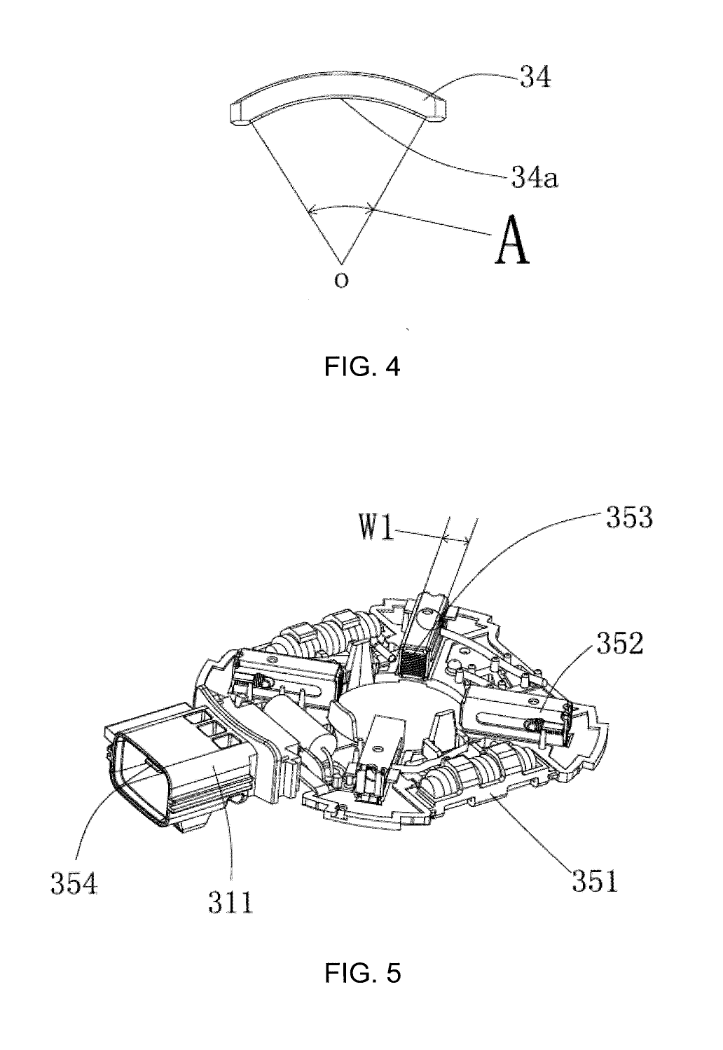

Referring to FIG. 4, the radial inner surface 34a of the permanent magnet 34 is an arc surface. The arc surface has a central angle A, relative to the axis O of the motor 200. The central angle A may range from 79.8 degrees to 83.8 degrees, which can effectively reduce the noise. Preferably, the central angle A is 81.8 degrees. In some embodiments, the central angle A also may range from 63.5 degrees to 67.5 degrees, or from 71.6 degrees to 75.6 degrees, which also can effectively reduce the noise. Preferably, the central angle A is 65.5 degrees or 73.6 degrees.

Referring to FIG. 5, the brush device 35 includes an insulated substrate 351, a plurality of brush holders 352 fixed on the insulate substrate 351, and a plurality of brushes 353 disposed into the corresponding brush holders 352. The insulated substrate 351 is mounted to one end of the housing 31, and fixed between the housing 31 and the second end cap 33. The brush device 35 is located away from the end of the shaft 61 for driving the load, so as to reduce the vibration of the brush device 35 caused by the load, and thus realizing a smooth commutation and reducing noise. The brush holder 352 is substantially rectangular box-shaped. The illustrated embodiment comprises two pairs of brush holders 352, each pair of which includes two brush holders 352 arranged along a diametrical direction of the motor 200. A connector is located at a side of the insulated substrate 352, which includes a connector housing 311 and at least two conductive terminals 354 fixed therein. The conductive terminals 354 are configured to connect an external power supply and power the motor 200.

The rotor 60 includes a shaft 61, a rotor core 62 sleeved on the shaft 61, a commutator 64, and a winding 63 wound around the rotor core 62 and connected to the commutator 64. The shaft 61 is supported by the bearings respectively arranged on the first end cap 32 and the second end cap 33, to ensure the shaft 61 rotates with respect to the stator 30. The rotor core 62 is disposed in a receiving space formed by the four permanent magnets 34. A gap is defined between the rotor core 62 and the permanent magnets 34.

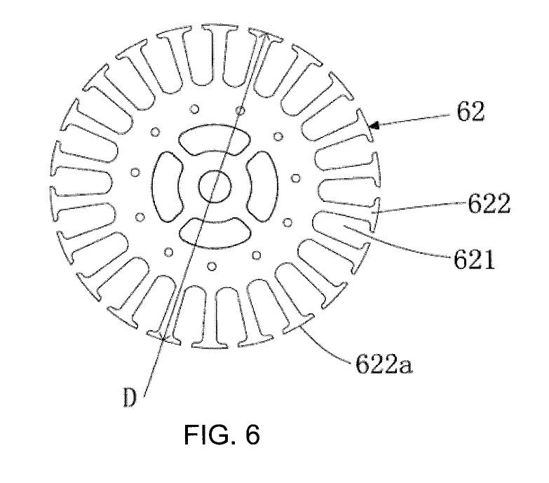

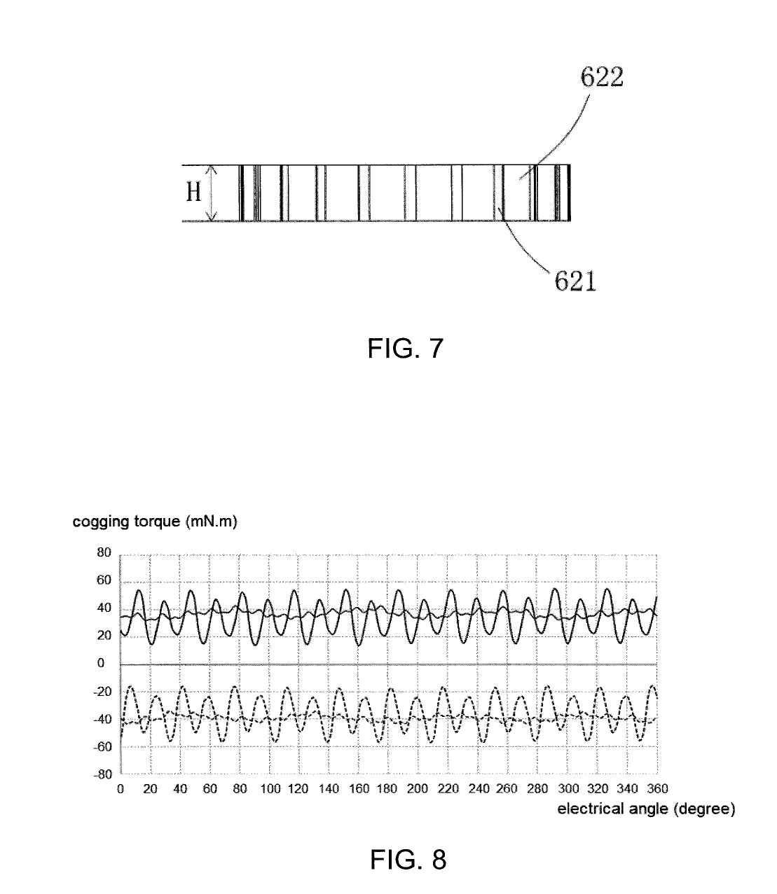

Referring to FIGS. 6 and 7, the rotor core 62 includes twenty-two winding slots 621 evenly distributed on a periphery of the rotor core 62 and twenty-two teeth 622. Each tooth 622 is formed between two adjacent winding slots 621. The winding 63 is wound around the teeth 622. The ratio of the diameter D of the rotor core 62 to the thickness H of the rotor core 62 is greater than 2, so that the motor is a flat cylinder to accommodate the brushes 353 have long radial lengths, thereby increasing the life of the brush device 35. In the illustrated embodiment, each of the winding slots 621 is a vertical slot, which is parallel to the axial direction of the motor 200. The twenty-two teeth 622 of the rotor 60 forms twenty-two rotor poles. The motor 200 in the present invention is a 4-pole 22-slot motor. The radial outer surface of each tooth 622 is an arc surface 622a. The gap is formed between the two arc surfaces 622a, 34a, so that the rotor 60 is rotatable relative to the stator 30.

Preferably, the rotor core 62 includes a plurality of laminations stacked along the axial direction of the motor 200. Each lamination is centrosymmetric, and has twenty-two slots evenly distributed on the periphery of the lamination and twenty-two tooth portions. Each tooth portion is formed between the two adjacent slots. The slots are stacked to form the twenty-two winding slots 621 of the rotor 60. The tooth portions are stacked to form twenty-two teeth 622 of the rotor 60.

FIG. 8 illustrates a comparison of a cogging torque of the 4-pole 20-slot motor according to the conventional technology and a cogging torque of the 4-pole 22-slot motor according to the present invention, wherein the horizontal axis refers to the electrical angle of the rotor 60, and the vertical axis refers to the corresponding cogging torque. The upper half of FIG. 8 shows the cogging torque curves when the rotors rotates clockwise; the lower half of FIG. 8 shows the cogging torque curves when the rotors rotates counterclockwise. L1 and L3 respectively signify the cogging torque curves when the conventional 4-pole 20-slot motor rotates clockwise and counterclockwise. L2 and L4 respectively signify the cogging torque curves when the 4-pole 22-slot motor 200 of the present invention rotates clockwise and counterclockwise. It is apparent that L1 and L3 have large peak fluctuations, so the conventional 4-pole 20-slot motor has a large cogging torque, as a consequence, the conventional motor has a large vibration and noise. L2 and L4 have small peak fluctuations, so the 4-pole 22-slot motor 200 has a small cogging torque, and thus having a small vibration and noise. In addition, the motor 200 has more slots, so each slot has less conductors, and thus the reactance potential of the winding 63 is small during commutation, the commutation spark is small, and consequently, the motor 200 has a long life.

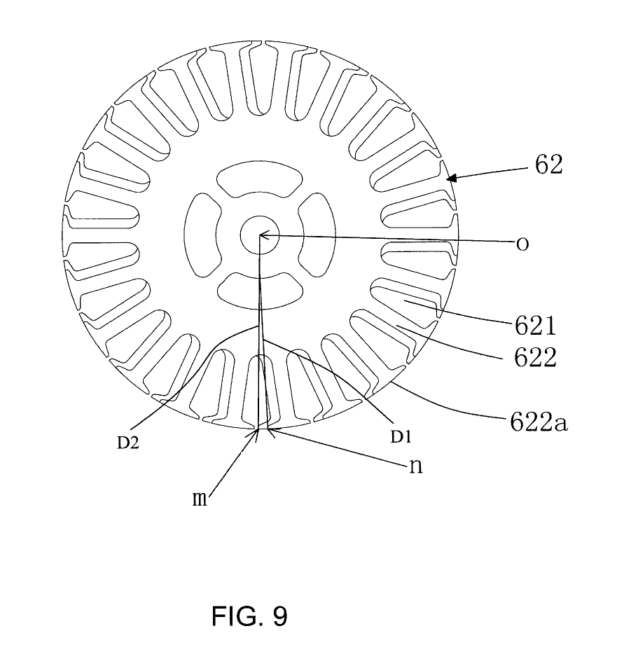

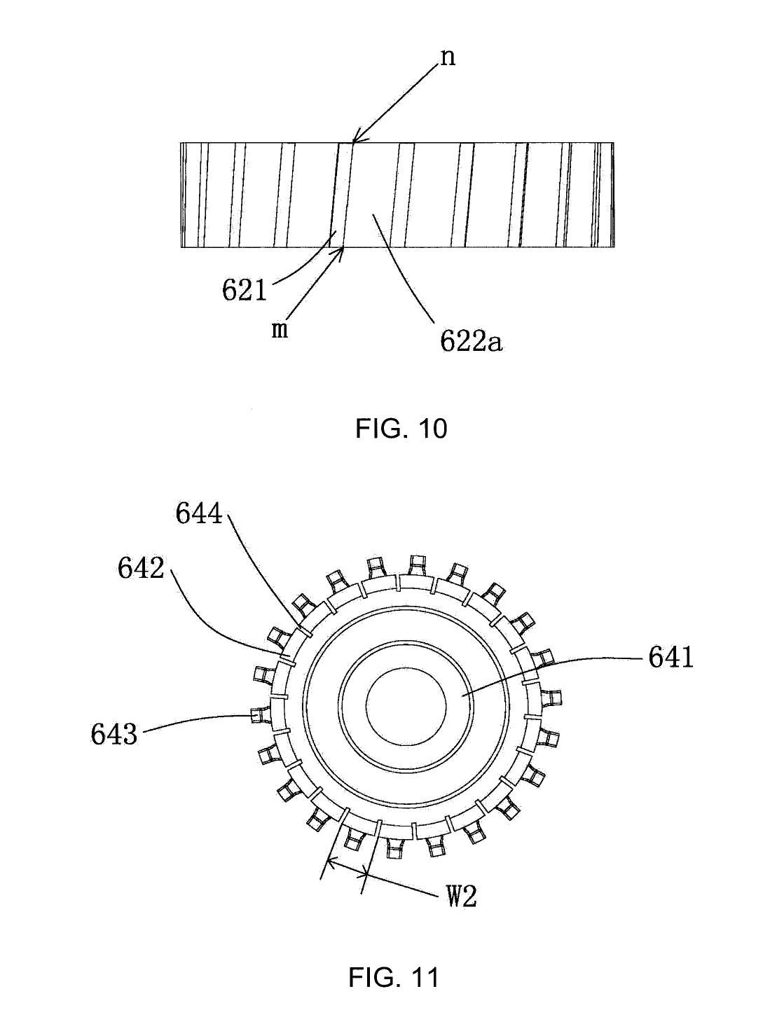

FIGS. 9 and 10 show an alternate rotor core 62. In this embodiment, the winding slots 621 of the rotor core 62 are paralleled to each other, but inclined relative to the axial direction of the motor 200. The axial upper end n of the inclined slot 621 is offset by an offset angle with respect to the axial lower end m of the same inclined slot 621, wherein the offset angle ranges from 7.98 degrees to 8.38 degrees, and preferably is 8.18 degrees. The offset angle refers to an angle formed between a first dummy line D1 and a second dummy line D2. The first dummy line D1 refers to a projection of a line connecting the axial upper end n and the axis O, in the axial direction of the motor 200. The second dummy line D2 refers to a projection of a line connecting the axial lower end m and the axis O, in the axial direction of the motor 200.

Referring to FIG. 11, the commutator 64 includes an insulating base 641 and twenty-two segments 642 fixed to the radial outer periphery of the insulating base 641. The insulating base 641 is sleeved on the shaft 61. Each segment 642 extends along the axial direction of the motor 200. The inner side of each brush 353 is in sliding contact with the segment 642. A plurality of hook portions 643 are formed at the ends of the segments 642 close to the rotor core 62, for hooking the winding 63. Every two adjacent segments 642 forms an insulating groove 644 therebetween. Preferably, the ratio of W1 to W2 ranges from 0.9 to 1.3, wherein W1 refers to the width of the brush 353 along the circumferential direction as labeled in FIG. 5, W2 refers to the sum of the width of the segment 642 and the width of the insulating groove 644 adjacent to the segment 642. Said ratio makes the motor 200 have a high stability and a high working efficiency.

The above descriptions are only preferred embodiments of the present disclosure, and are not to limit the present disclosure. Any changes, equivalents, modifications and the like, which are made within the spirit and principle of the present disclosure, shall fall within the protection scope of the present disclosure.

1. A cooling fan module for heat dissipation of an automobile engine, comprising:
a fan assembly, and
a brush motor for driving the fan assembly, comprising:
a stator, comprising a housing and a plurality of permanent magnets fixed onto an inner wall of the housing, and
a rotor, comprising a shaft, a rotor core sleeved on the shaft, and a winding wound around the rotor core,
wherein the number of the permanent magnets is four, the rotor core comprises twenty-two winding slots evenly distributed on a periphery of the rotor core and twenty-two teeth, each of the teeth being formed between two adjacent winding slots.

2. The cooling fan module according to claim 1, wherein the rotor core comprises a plurality of laminations stacked along an axial direction of the brush motor, each lamination has twenty-two slots and twenty-two tooth portions, the slots are stacked to form the winding slots, and the tooth portions are stacked to form the teeth.

3. The cooling fan module according to claim 2, wherein each lamination is centrosymmetric.

4. The cooling fan module according to claim 1, wherein each winding slot is parallel to an axial direction of the brush motor.

5. The cooling fan module according to claim 1, wherein the winding slots are paralleled to each other, but inclined relative to an axial direction of the brush motor.

6. The cooling fan module according to claim 5, wherein an axial upper end of the winding slot is offset by an offset angle with respect to an axial lower end of the same winding slot, and wherein the offset angle ranges from 7.98 degrees to 8.38 degrees.

7. The cooling fan module according to claim 6, wherein the offset angle is 8.18 degrees, the offset angle refers to an angle formed between a first dummy line and a second dummy line, the first dummy line refers to a projection of a line connecting the axial upper end and an axis of the brush motor, in an axial direction of the brush motor, the second dummy line refers to a projection of a line connecting the axial lower end and the axis, in the axial direction of the brush motor.

8. The cooling fan module according to claim 1, wherein the four permanent magnets are uniformly distributed on the inner wall of the housing in a circumferential direction of the brush motor, a radial inner surface of the permanent magnet has a central angle relative to an axis of the brush motor, and the central angle ranges from 79.8 degrees to 83.8 degrees, 71.6 degrees to 75.6 degrees, or 65.5 degrees or 73.6 degrees.

9. The cooling fan module according to claim 1, wherein a ratio of a diameter of the rotor core to a thickness of the rotor core is greater than 2.

10. The cooling fan module according to claim 1, wherein the stator further comprises a brush device mounted to one end of the housing, the rotor further comprises a commutator sleeved on the shaft, the commutator is connected to the winding and in contact with brushes of the brush device, the commutator comprises an insulating base sleeved on the shaft, twenty-two segments fixed to a radial outer periphery of the insulating base, and twenty-two insulating grooves, each insulating groove being formed between the two adjacent segments.

11. The cooling fan module according to claim 10, wherein a ratio of W1 to W2 ranges from 0.9 to 1.3, wherein W1 refers to a width of the brush, W2 refers to a sum of a width of the segment and a width of the insulating groove adjacent to the segment.
